(19) United States
(12) Patent Application Publication
(10) Pub. No.: US 2022/0118876 A1
(43) Pub. Date: Apr. 21, 2022

(54) Method For Authenticating And Releasing A Charging Process Of An Electric Or Hybrid Vehicle At A Charging Station, Charging Station And Electric Or Hybrid Vehicle

(71) Applicant: Volkswagen Aktiengesellschaft, Wolfsburg (DE)

(72) Inventor: Simon Gerlach, Wasbuttel (DE)

(73) Assignee: Volkswagen Aktiengesellschaft, Wolfsburg (DE)

(21) Appl. No.: 17/500,175

(22) Filed: Oct. 13, 2021

(30) Foreign Application Priority Data
Oct. 15, 2020 (DE) 10 2020 213 061.2

(51) Int. Cl. B60L 53/65; H02J 7/00; B60L 53/18

(52) U.S. Cl. CPC B60L 53/65; B60L 53/18; H02J 7/0042; H02J 7/00045

(57) ABSTRACT

The disclosure relates to a charging station comprising a charging cable, or a charging socket for receiving a charging cable, and a memory with a list of IDs that are authorized to use the charging station. The charging station is configured to receive an ID via the charging cable and to compare it with the IDs on the list. A charging process is or is not authorized depending on the comparison. The charging station is furthermore configured to receive an enabling code, wherein after the charging station confirms the enabling code, a subsequently received ID of an electric or hybrid vehicle is saved in the list.

### CROSS-REFERENCE TO RELATED APPLICATIONS

This application claims priority to German Patent Application No. DE 10 2020 213 061.2, filed on Oct. 15, 2020 with the German Patent and Trademark Office. The contents of the aforesaid Patent Application are incorporated herein for all purposes.

### TECHNICAL FIELD

The invention relates to a method for authenticating and releasing a charging process of an electric or hybrid vehicle at a charging station, a charging station and an electric or hybrid vehicle.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In particular with private charging stations, a problem arises of protecting them from misuse on the one hand and configuring the charging process as simply as possible on the other hand. If the charging stations are permanently energized, there is no protection against misuse. If contrastingly the authentications are overly complex, this is annoying to the authorized user.

### SUMMARY

A need exists for providing a more user-friendly method for authenticating and releasing a charging process of an electric or hybrid vehicle at a charging station, for providing a suitable charging station, as well as for providing a suitable electric or hybrid vehicle.

The need is addressed by a method, a charging station, as well as an electric or hybrid vehicle according to the independent claims. Embodiments of the invention are described in the dependent claims, the following description, and the drawings.

### BRIEF DESCRIPTION OF THE DRAWING

FIG. 1 shows a schematic representation of an embodiment of an electric vehicle and a charging station.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for authenticating and releasing a charging process for an electric or hybrid vehicle at a charging station is provided, wherein an ID is transmitted by the electric or hybrid vehicle via a charging cable to the charging station, wherein the charging station receives the ID and checks whether there is an authorization for the ID to use the charging station in a list (white list) in the charging station, wherein the charging process is started when the authorization exists. This method has a series of benefits. One benefit is that the user does not have to engage in a special interaction (such as actuating a key or entering a pin code). The method may run automatically between the electric or hybrid vehicle and charging station, and is for example started by plugging in the charging cable. The charging station does not require any connection to a backend, and the vehicle does not require any additional interfaces to communicate with the charging station. The communication may be started by the electric or hybrid vehicle, or by the charging station. The ID is for example the unique vehicle ID, or another ID. Communication may be unencrypted or encrypted.

There are various options for the initial entry of the ID of a vehicle into the list.

In some embodiments, the electric or hybrid vehicle transmits an enabling code via the charging cable to the charging station, wherein after the enabling code is confirmed by the charging station, the electric or hybrid vehicle transmits an ID to the charging station that is then received by the charging station and saved in the list.

In some embodiments, the charging station is enabled by a local input (unit) arranged on the charging station, and an ID of an electric or hybrid vehicle connected via a charging cable to the charging station is transmitted to the charging station and saved in the list of the charging station as authorized for the future. The input may example be a lock, an entry keyboard, keypad, touchpad, or a card reader, without limitation.

In some embodiments, an ID of an electric or hybrid vehicle is transmitted by a backend to the charging station, wherein the charging station then saves the transmitted ID in the list. Accordingly for example, the user of the charging station may transmit the ID to the charging station beforehand by a computer or a mobile communications terminal device so that the ID is then already in the list before the motor vehicle to be charged appears at the charging station.

In some embodiments, at least individual IDs are assigned usage restrictions in the list of authorized IDs, for example how often or how long the IDs may use the charging station. The extractable electrical energy may also be restricted.

In some embodiments, a release for energy transmission by the charging station is ended by removing the charging cable from the electric or hybrid vehicle, which prevents potential manipulations.

In some embodiments, a charging station is provided that comprises a charging cable, or a charging socket for receiving a charging cable, and a memory with a list of IDs that are authorized to use the charging station, wherein the charging station is designed to receive an ID via the charging cable and compare it with the IDs in the list, wherein the charging process is or is not released depending on the comparison.

In some embodiments, the charging station is also designed to receive an enabling code, wherein after the charging station confirms the enabling code, a subsequently received ID of an electric or hybrid vehicle is saved in the list.

In some embodiments, an electric or hybrid vehicle comprises a charging socket and a memory with an ID, wherein the electric or hybrid vehicle is designed to transmit an ID via a charging cable plugged into the charging socket, wherein the electric or hybrid vehicle is furthermore designed to transmit an enabling code via the plugged-in charging cable before the ID.

With respect to potential additional embodiments of the charging station and the electric or hybrid vehicle, reference is made to the above and below discussion of embodiments.

Reference will now be made to the drawings in which the various elements of embodiments will be given numerical designations and in which further embodiments will be discussed.

In the exemplary embodiments described herein, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

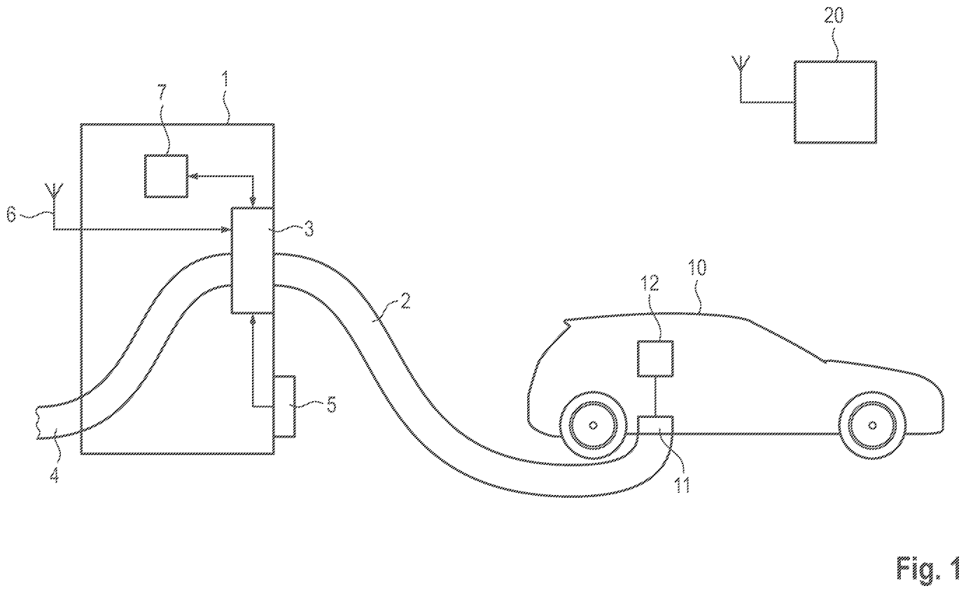

FIG. 1 shows a charging station 1. The charging station 1 has a charging cable 2 that is designed to be plugged into a charging socket 11 of an electric vehicle 10. The charging cable 2 has lines for transmitting energy and lines for communication that are not shown for reasons of clarity. The charging station 1 furthermore has a control circuit 3 with a processor (not shown) that is designed to release or prevent a charging process at the charging station 1. To accomplish this, the control circuit 3 has for example switching elements (not shown), by means of which the connection between the lines for the energy transmission by the charging cable 2 and the lines 4 of a voltage supply is established or interrupted. Furthermore, the charging station 1 has an input 5 and/or a data interface 6 to a backend 20. Finally, the charging station 1 has a memory 7 with a list of IDs that have an authorization to use the charging station 1. The electric vehicle 10 also has a memory 12 in which an ID for the electric vehicle 10 is saved. It may also be provided that the charging cable 1 is not fixedly connected to the charging station 1, and the charging cable 1 for the charging process must be plugged both into the charging station 1 as well as into the electric vehicle 10.

The procedure for authenticating and releasing a charging process of the electric vehicle 10 at the charging station 1 will now be explained. The charging station 1 is a private (i.e., non-public) charging station 1. In the initial state, the control circuit 3 has opened the connection between the switching elements. When the electric vehicle 10 arrives at the charging station 1, the user plugs the charging cable 2 by its charging plug into the charging socket 11 of the electric vehicle 10. The electric vehicle 10 then transmits its ID from the memory 12 via the charging cable 2 to the control circuit 3, wherein the transmission is via a communication line (such as a pilot), or via a line for transmitting energy. The control circuit 3 receives the ID and checks whether the ID is in the list in the memory 7. If this is the case, the switching elements are closed, and the charging process is released. If the ID is contrastingly not in the list, the switching elements therefore remain open.

There are various options for entering the ID into the list for the first time. Accordingly for example the user may enter a PIN code via the input 5, or release the charging process by a card or a key, wherein the received ID of the electric vehicle 10 is then written into a list in the memory 7 by the control circuit 3. Alternatively, the electric vehicle 10 may transmit an enabling code via the charging cable before transmitting the ID to the charging station, after which the control circuit 3 then also enters the ID into the list. Finally, a backend 20 may also transmit the ID beforehand to the data interface 6.

### LIST OF REFERENCE NUMERALS

1 Charging station
2 Charging cable
3 Control circuit
4 Line
5 Input
6 Data interface
7 Memory
10 Electric vehicle
11 Charging socket
12 Memory
20 Backend

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for authenticating and releasing a charging process for an electric or hybrid vehicle at a charging station, comprising in case of an initial entry of an ID of the vehicle into a list of the charging station:
transmitting by the electric or hybrid vehicle an enabling code to the charging station via a connected charging cable;
confirming the enabling code by the charging station;
transmitting by the electric or hybrid vehicle the ID to the charging station; and
receiving the ID by the charging station and saving the ID in the list.

2. The method of claim 1, wherein the charging station is enabled by a local input arranged on the charging station, and an ID of an electric or hybrid vehicle connected via a charging cable to the charging station is transmitted to the charging station and saved in the list of the charging station as a future authorization.

3. The method of claim 1, wherein an ID of an electric or hybrid vehicle is transmitted by a backend to the charging station, and the charging station saves the transmitted ID in the list.

4. The method of claim 1, wherein at least one ID in the list is assigned a usage restriction.

5. The method of claim 1, wherein a release of the charging station is ended by removing the charging cable from the electric or hybrid vehicle.

6. A charging station comprising a charging cable, or a charging socket for receiving a charging cable, and a memory with a list of IDs that are authorized to use the charging station; wherein the charging station is configured to receive an ID via the charging cable and to compare it with the IDs on the list; wherein a charging process is or is not authorized depending on the comparison; wherein the charging station is furthermore configured to receive an enabling code, wherein after the charging station confirms the enabling code, a subsequently received ID of an electric or hybrid vehicle is saved in the list.

7. An electric or hybrid vehicle comprising a charging socket and a memory with an ID; wherein the electric or hybrid vehicle is configured to transmit the ID via a charging cable plugged into the charging socket; wherein the electric or hybrid vehicle is furthermore configured to transmit an enabling code via the plugged-in charging cable before the ID is transmitted.

8. A method for authenticating and releasing a charging process for an electric or hybrid vehicle at a charging station, comprising in case of an initial entry of an ID of the vehicle into a list of the charging station:
providing, by a local input of the charging station, an enabling code;
confirming the enabling code by the charging station and upon confirmation, enabling the charging station;
transmitting, by the electric or hybrid vehicle, the ID to the charging station; and
receiving the ID by the charging station and saving the ID in the list.

9. The method of claim 2, wherein an ID of an electric or hybrid vehicle is transmitted by a backend to the charging station, and the charging station saves the transmitted ID in the list.

10. The method of claim 2, wherein at least one ID in the list is assigned a usage restriction.

11. The method of claim 3, wherein at least one ID in the list is assigned a usage restriction.

12. The method of claim 2, wherein a release of the charging station is ended by removing the charging cable from the electric or hybrid vehicle.

13. The method of claim 3, wherein a release of the charging station is ended by removing the charging cable from the electric or hybrid vehicle.

14. The method of claim 4, wherein a release of the charging station is ended by removing the charging cable from the electric or hybrid vehicle.
